(19) United States
(12) Patent Application Publication
(10) Pub. No.: US 2007/0086673 A1
(43) Pub. Date: Apr. 19, 2007

(54) Reducing video flicker by adaptive filtering

(76) Inventors: Todd Witter, Orangevale, CA (US); Satya Avadhanam, Folsom, CA (US)

Correspondence Address: INTEL CORPORATION;C/O INTELLEVATE, LLC, P.O. BOX 52050, MINNEAPOLIS, MN, 55402, US

(21) Appl. No.: 11/251,599

(22) Filed: Oct. 14, 2005

(51) Int. Cl. G06K 9/40

(52) U.S. Cl. 382/269

(57) ABSTRACT

A method of reducing video flicker by adaptive filtering may include receiving a group of lines of video data and detecting one or more edges within the group of lines of video data. Pixels that are associated with the one or more edges may be filtered using a first set of filter coefficients. Pixels that are not associated with the one or more edges using may be filtered a second set of filter coefficients that is different from the first set of filter coefficients.

### BACKGROUND

Implementations of the claimed invention generally may relate to schemes for enhancing display information and, more particularly, to such schemes that reduce flickering in displayed information.

Sometimes it is desirable to display information (e.g., video information, graphics information, or some combination thereof) that has been formatted at a somewhat higher resolution on a monitor that has a somewhat lower resolution (e.g., vertically, horizontally, or both). For example, one may wish to display graphics and/or video information that has been formatted for a higher-definition display, such as a personal computer (PC) display, on an interlaced display (e.g., a television or another interlaced display device) that has a lower bandwidth (e.g., in the vertical direction) than that of the PC display. It should be noted that the terms “PC display” and/or “PC-formatted” are merely convenient shorthand for high-resolution displays and/or formatting generally (e.g., video graphics array (VGA), super VGA (SVGA), extended graphics array (XGA), high definition (HD) video, etc.), and should not be construed to limit the description herein.

In such a case, the PC-formatted information to be displayed on the interlaced display may include abrupt transitions (e.g., edges) that may cause undesired visual “flicker” (i.e., inconstant or wavering light) when displayed, unaltered, on the interlaced display. One possible scheme to avoid flicker may be to provide overall softening of the whole displayed image.

Some a scheme for reducing flicker, however, may also unacceptably reduce perceived image quality by reducing overall sharpness of the displayed information.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates a portion of a video display system; and

FIG. 2 illustrates an exemplary process of adaptively filtering graphical or video data.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

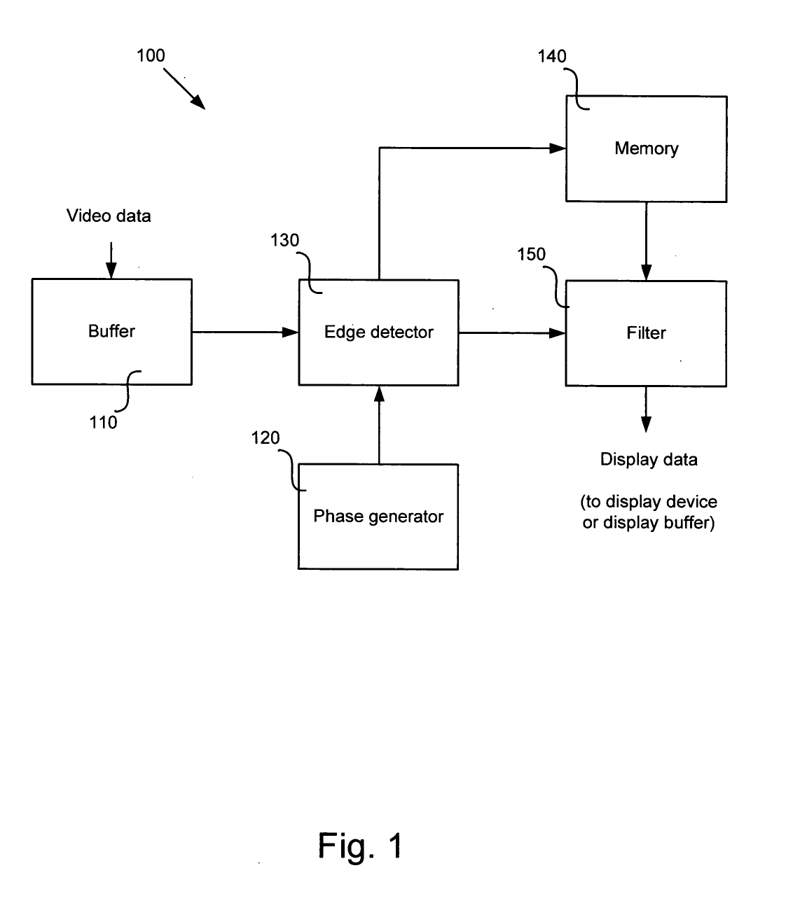

FIG. 1 illustrates a portion of a video display system 100. System 100 may receive video information from any suitable medium, including but not limited to various transmission and/or storage media. Although illustrated as separate functional elements for ease of explanation, any or all of the elements of system 100 may be co-located and/or implemented by a common group of gates and/or transistors. Further, system 100 may be implemented via software, firmware, hardware, or any suitable combination thereof.

Display system 100 shown in FIG. 1 may include a buffer 110, a phase generator 120, an edge detector 130, a memory 140, and a filter 150. Buffer 110 may be arranged to receive and temporarily store data in a number of formats that may include, but are not limited to, MPEG-1, MPEG-2, MPEG-4, Advanced Video Coding (AVC) (e.g., MPEG-4, part 10 and ITU-T Recommendation H.264), Windows Media Video 9 (WMV-9), SMPTE's VC-1, VGA format, SVGA format, and/or XGA format. In some implementations, buffer 110 may buffer one or more lines of video information, or some portion of one or more lines of video information. Although buffer 110 may be illustrated as a single component for ease of illustration, it may include, in some implementations, a number of discrete buffers 110, each of which may be arranged to store one or more lines of video information.

Phase generator 120 may be arranged to generate a phase signal, for eventual use with filter 150, that is related to the input to buffer 110 and the output of filter 150. In some implementations, phase generator 120 may include a digital difference accumulator (DDA), and in some implementations, phase generator 120 may include a vertical DDA. The output of phase generator 120 may represent a phase of filter 150.

In some implementations, the output of phase generator 120 may include actual coefficients of filter 150. In the implementation illustrated in FIG. 1, however, the coefficients used for filter 150 may be stored in memory 140. Hence, the output of phase generator 120 may include an index or other scheme for selecting a particular coefficient or set of coefficients from memory 140. For example, in some implementations one or more bits of the output of phase generator 120 may be used to generate an index for filter coefficients stored in memory 140.

Edge detector 130 may be arranged to detect edges (i.e., sufficiently abrupt transitions) in one or more lines of data from buffers 110. Edge detector 130 may detect two types of edges: one where a single abrupt transition occurs in an area of interest (e.g., a “step” function-type edge), and another where two abrupt transitions occur in an area of interest (e.g., an “impulse” function-type edge). For a particular area in a line of data where the gradient between pixels does not meet a threshold level to be designated as an edge, edge detector 130 may designate such an area as “normal” data. In some implementations, edge detector 130 may be a matrix-type detector arranged to find edges in three, five, seven, etc. lines of data that are adjacent to and include a line of interest.

Edge detector 130 may also be arranged to selectively alter the output of phase generator 120. For example, if edge detector 130 does not determine that a given pixel (or group of pixels) is part of an edge, it may pass the output of phase generator 120 to memory 140 unaltered. If edge detector 130 determines that a given pixel is part of an edge, however, it may impart an offset or otherwise alter the output of phase generator 120 so that another part of memory 140 is accessed. Further, edge detector 130 may alter values from phase generator 120 differently for “step” edges than for “impulse” edges. Edge detector 130 may input this selectively altered value to memory 140.

Edge detector 130 may also pass lines of video/graphical information (or portions thereof) that were received from buffer 110 to filter 150. For example, if edge detector 130 is determining edges for a particular line of interest, it may pass this line of data (or individual pixels from that line) to filter 150 at appropriate times.

Memory 140 may include writable memory, such as random access memory (RAM), and may be arranged to store coefficients for filter 150. Memory 140 may include a look-up table or other data structure (e.g., array, linked list, etc.) that holds the coefficients. The coefficients may be loaded into, for example, a look up table in memory 140 by software on a processor (not shown) before filter 140 is enabled. The particular coefficients loaded may be based on the knowledge of desired output format, television or other video/graphics standard of the input to buffer 110, and one or more scaling factors.

Conceptually, memory 140 may include one set of coefficients for pixels that are “normal,” another set of coefficients for pixels that are on and/or adjacent “step” edges, and another set of coefficients for pixels that are on and/or adjacent “impulse” edges. These different sets of coefficients may be separated or commingled in memory 140, depending on design considerations and the operation of edge detector 130. Memory 140 may pass filter coefficients for a line of data that is of interest (or for individual pixels from that line) to filter 150 at appropriate times.

Filter 150 may be arranged to receive pixels of data from edge detector 130 (or in some implementations, from buffer 110) and to filter them using coefficients from memory 140. In some implementations, filter 150 may include a vertical polyphase filter. Filter 150 may prepare a signal for transmission or display with a lower bandwidth (e.g., lower than that of a VGA monitor). Filter 150 may also scale its input to the size of the desired output format (e.g., from 1024×768 down to the NTSC size of 720×480).

Filter 150 may also interlace the output data and perform flicker reduction. The process of interlacing is performed by filter 150, and a typical artifact of the interlacing function may be visual flicker. Because edge detector 130 causes memory 140 to pass different filter coefficients for edge pixels, however, filter 150 may also reduce flicker, relative to a single, non-adaptive set of coefficients, when interlacing its output data. Filter 150 may filter its input data on a per-pixel basis, and may output display data to a display device or display buffer (not shown).

Although illustrated as being connected in a certain manner for ease of illustration, system 100 in FIG. 1 may be implemented in other configurations. For example, in some implementations, buffer 110 may be incorporated into edge detector 130, instead of as a separate element as shown. In some implementations, the combination of memory 140 and filter 150 may be replaced by a number of dedicated filters. Other variations are both possible and contemplated.

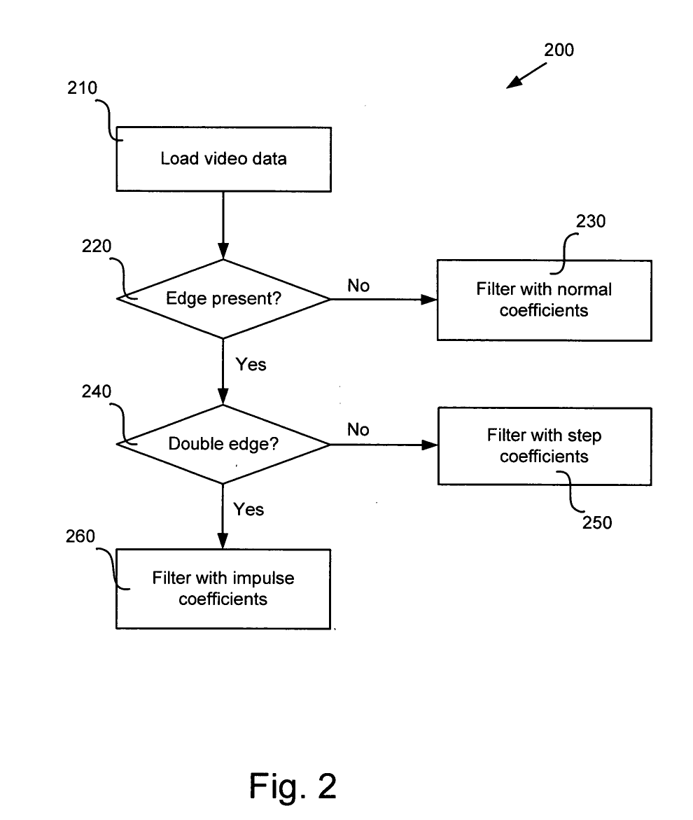

FIG. 2 illustrates an example process 200 of adaptively filtering graphical or video data. Although FIG. 2 may be described with regard to system 100 in FIG. 1 for ease and clarity of explanation, it should be understood that process 200 may be performed by other hardware and/or software implementations.

Processing may begin by loading a number of lines of video data [act 210]. For example, a line data that is of interest along with one or more adjacent lines of data may be loaded into buffer 110. In some implementations, five lines of data may be loaded including the line of interest, two lines above it, and two lines below it. It should be noted, however, that more or less data may be loaded in act 210.

Processing may continue with edge detector 130 determining whether an edge is present for a region of interest (e.g., a pixel or group of pixels) [act 220]. Various techniques are available to determine whether a gradient or edge is present in a particular line of data. Edge detector 130 may use convolution, a derivative, and/or another matrix operation, for example, on an area including the pixel in question and adjacent pixels to determine a value (or values). If the value(s) does not exceed a threshold (e.g., if there is not a sufficiently sharp transition), edge detector 130 may determine that a certain pixel is not part of or adjacent to an edge.

If no edge is present, edge detector 130 may cause filter 150 to filter the pixel or group of pixels with “normal” coefficients [act 230]. Edge detector 130 may not alter, in such a case, the indexing value(s) from phase generator 120 to choose coefficient(s) from memory 140. In short, where edge detector 130 determines that no edge is present, phase generator 120 may cause memory 140 to output coefficients to filter 150 from a default or normal set.

If an edge is detected, edge detector 130 may determine whether a double edge (i.e., two adjacent transitions of sufficient magnitude) is present [act 240]. In doing so, edge detector 130, upon finding one transition, may check for the presence of another within a certain, predetermined distance of the first transition. If edge detector 130 does not find a second adjacent edge, it may classify the edge as a “step” type discontinuity. If edge detector 130 does find a second adjacent edge, however, it may classify the edge as an “impulse” type discontinuity.

In the former case, if no second edge is sufficiently close, edge detector 130 may cause filter 150 to filter the pixel or group of pixels with “step” coefficients [act 250]. Edge detector 130 may alter, in such a case, the indexing value(s) from phase generator 120 to choose coefficient(s) from memory 140 that are intended for step-type discontinuities (e.g., one transition). In brief, where edge detector 130 determines that only one edge is present within a certain area, phase generator 120 may cause memory 140 to output coefficients to filter 150 from a step set of coefficients. Such filtering with dedicated coefficients may reduce visual flicker from step-type edges, without unduly softening the entire image.

In the latter case, if a second edge is sufficiently close, edge detector 130 may cause filter 150 to filter the pixel or group of pixels with “impulse” coefficients [act 260]. Edge detector 130 may alter, in such a case, the indexing value(s) from phase generator 120 to choose coefficient(s) from memory 140 that are intended for impulse-type discontinuities (e.g., two transitions). In sum, where edge detector 130 determines that two edges are present within a certain area, phase generator 120 may cause memory 140 to output coefficients to filter 150 from an impulse set of coefficients. Such filtering with dedicated coefficients may reduce visual flicker from impulse-type edges, without unduly softening the entire image.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the invention.

For example, although the scheme described herein may be performed on a pixel-by-pixel basis, it may also be performed for aggregations or groups of pixels in an image. Also, although the scheme herein is described with different coefficients for step and impulse transitions, it may also be implemented with one set of filter coefficients for non-edges and another set of coefficients for edges, regardless of the presence or absence of adjacent edges (i.e., the same coefficients for step-type and impulse-type discontinuities). Further, although the techniques herein have been described primarily with regard to vertically filtering of lines of data to produce interlaced output, such techniques may be applied to any scheme for adaptively filtering graphical and/or video information based on the presence or absence of edges to reduce flicker.

Further, the acts in FIG. 2 need not be implemented in the order shown; nor do all of the acts necessarily need to be performed. Also, those acts that are not dependent on other acts may be performed in parallel with the other acts. Further, at least some of the acts in this figure may be implemented as instructions, or groups of instructions, implemented in a machine-readable medium.

No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed is:

1. A method, comprising:
receiving a line of video data;
detecting one or more edges within the line of video data;
filtering pixels associated with the one or more edges using a first set of filter coefficients; and
filtering pixels not associated with the one or more edges using a second set of filter coefficients that is different from the first set of filter coefficients.

2. The method of claim 1, further comprising:
loading the line of video data into a buffer.

3. The method of claim 1, wherein the detecting includes:
performing an operation on at least a portion of the line of video data and at least one adjacent line of video data to generate a value; and
comparing the value with a threshold to determine whether an edge is present.

4. The method of claim 1, wherein the detecting includes:
detecting a first edge in the line of video data; and
determining whether a second edge is within a predetermined distance of the first edge.

5. The method of claim 4, wherein the filtering pixels associated with the one or more edges includes:
filtering pixels associated with the first edge using a third set of filter coefficients within the first set if the determining does not find the second edge within the predetermined distance.

6. The method of claim 4, wherein the filtering pixels associated with the one or more edges includes:
filtering pixels associated with the first edge and the second edge using a fourth set of filter coefficients within the first set if the determining finds the second edge within the predetermined distance.

7. A system, comprising:
a phase generator to choose filter coefficients for filtering video information;
an edge detector connected to the phase generator to recognize edges in the video information and to alter the filter coefficients chosen by the phase generator for the edges in the video information; and
a filter operatively coupled to the phase generator and the edge detector to selectively filter the video information using the filter coefficients chosen by the phase generator and the filter coefficients altered by the edge detector.

8. The system of claim 7, further comprising:
a buffer connected to the edge detector to store the video information.

9. The system of claim 7, further comprising:
a memory connected between the edge detector and the filter to store the filter coefficients and to input the filter coefficients to the filter.

10. The system of claim 9, wherein the filter coefficients input to the filter by the memory are chosen by the phase generator or the edge detector.

11. The system of claim 9, wherein the memory includes a random access memory.

12. The system of claim 7, wherein the filter is a polyphase filter.

13. The system of claim 7, wherein the edge detector is arranged to detected single edges that are not within a predetermined distance from another edge and double edges that are within the predetermined distance from each other.

14. The system of claim 7, wherein the edge detector is arranged to alter the filter coefficients chosen by the phase generator for the single edges differently than the edge detector alters the filter coefficients chosen by the phase generator for the double edges.

15. The system of claim 7, further comprising:
a display buffer coupled to an output of the filter.

16. A method, comprising:
receiving display data;
identifying edges within the display data;
filtering pixels in the display data that are associated with the edges differently from pixels in the display data that are not associated with the edges to reduce visual flicker at the edges.

17. The method of claim 16, wherein the filtering includes:
loading filter coefficients from a first set of filter coefficients for pixels in the display data that are associated with the edges; and
loading filter coefficients from a second set of filter coefficients for pixels in the display data that are not associated with the edges.

18. The method of claim 16, wherein the identifying includes:
determining whether an edge is a step edge having a single transition or an impulse edge having two transitions.

19. The method of claim 18, wherein the filtering includes:
loading filter coefficients from a set of step coefficients for pixels in the display data that are associated with step edges;
loading filter coefficients from a set of impulse coefficients for pixels in the display data that are associated with impulse edges; and
loading filter coefficients from a set of normal coefficients for pixels in the display data that are not associated with step edges or impulse edges.

20. The method of claim 16, wherein the identifying includes:
performing an operation on a plurality of lines of the display data to generate a result; and
determining whether an edge is present based on the result and a threshold function.
